(19) United States
(12) Patent Application Publication
(10) Pub. No.: US 2012/0138530 A1
(43) Pub. Date: Jun. 7, 2012

(54) METHOD AND APPARATUS FOR REMOVING ARSENIC FROM A SOLUTION

(75) Inventors: John L. Burba, III, Parker, CO (US); Carl R. Hassler, Gig Harbor, WA (US); C. Brock O'Kelley, Las Vegas, NV (US); Charles F. Whitehead, Las Vegas, NV (US)

(73) Assignee: MOLYCORP MINERALS, LLC, Greenwood Village, CO (US)

(21) Appl. No.: 11/958,968

(22) Filed: Dec. 18, 2007

Related U.S. Application Data
(60) Provisional application No. 60/882,401, filed on Dec. 28, 2006.

(51) Int. Cl. C02F 1/62; B01D 36/00; B01D 11/02; B01D 39/06; B01D 15/26; C25C 1/00; C01G 1/00

(52) U.S. Cl. 210/638; 210/688; 210/665; 210/259; 210/195.1; 210/251; 423/1; 205/771

(57) ABSTRACT

A method and apparatus for separating arsenic from an aqueous solution containing arsenic. The method includes the steps of contacting an arsenic-containing solution with a first portion of fixing agent to remove at least a portion of the arsenic. An arsenic-laden fixing agent is separated from the solution and the partially depleted solution is contacted with a second portion of fixing agent. The fixing agent can include a high surface area insoluble compound containing one or more of cerium, lanthanum, or praseodymium. Following removal of the arsenic, the arsenic-depleted solution can be further processed to separate a recoverable metal through metal refining. The arsenic-laden fixing agent can be filtered to recover and recycle a filtrate to the solution for additional treatment, as well as using a partially saturated fixing agent to remove arsenic from fresh solution. An arsenic-containing solution can be formed from arsenic-containing solids such as contaminated soils, industrial byproducts and waste materials.

### FIELD OF THE INVENTION

This invention relates generally to the removal of toxic metals from an aqueous solution, and specifically, to the removal of arsenic from aqueous solutions, such as industrial process streams, effluents, solutions prepared from byproducts and waste materials, and drinking water.

### BACKGROUND OF THE INVENTION

The presence of arsenic in waters, soils and waste materials may originate from or have been concentrated through geochemical reactions, mining and smelting operations, the land-filling of industrial wastes, the disposal of chemical agents, as well as past agricultural uses of arsenic-containing pesticides. Because the presence of high levels of arsenic may have carcinogenic and other deleterious effects on living organisms and because humans are primarily exposed to arsenic through drinking water, the U.S. Environmental Protection Agency (EPA) and the World Health Organization have set the maximum contaminant level (MCL) for arsenic in drinking water at 10 parts per billion (ppb). As a result, a problem facing industries such as mining, metal refining, steel manufacturing and power generation is the reduction or removal of arsenic from process streams, effluents and byproducts.

Arsenic occurs in the inorganic form in aquatic environments primarily the result of dissolution of solid phase arsenic such as arsenolite (As₂O₃), arsenic anhydride As₂O₅) and realgar (AsS₂). Arsenic occurs in water in four oxidation or valence states, i.e., −3, 0, +3, and +5. Under normal conditions arsenic is found dissolved in aqueous or aquatic systems in the +3 and +5 oxidation states, usually in the form of arsenite (AsO₂⁻¹) and arsenate (AsO₄⁻³). The effective removal of arsenic by coagulation techniques requires the arsenic to be in the arsenate form. Arsenite, in which the arsenic exists in the +3 oxidation state, is only partially removed by adsorption and coagulation techniques because its main form, arsenious acid (HAsO₂), is a weak acid and remains un-ionized at pH levels between 5 and 8 when adsorption is most effective.

Various technologies have been used to remove arsenic from aqueous systems. Examples of such techniques include adsorption on high surface area materials, such as alumina, activated carbon, lanthanum oxide and cerium dioxide, ion exchange with anion exchange resins, precipitation and electrodialysis. In the case of solid or semi-solid waste materials and byproducts containing arsenic, attempts have been made to solidify or stabilize the arsenic in situ to prevent migration into surrounding soils or groundwater. However, because such stabilization procedures tend to be quite costly, and in some cases are unproven, there is a need for alternate method and techniques for handing arsenic in such materials.

### SUMMARY OF THE INVENTION

In one embodiment, the present invention provides a method for separating arsenic from an arsenic-containing solution. The method includes the steps of contacting an arsenic-containing solution with a first portion of fixing agent under conditions in which at least a portion of the arsenic is fixed by the fixing agent to yield a partially-depleted solution and an arsenic-laden fixing agent. The fixing agent comprises a rare earth-containing compound. The rare-earth containing compound can include one or more of cerium, lanthanum, or praseodymium. More specifically, the rare-earth containing compound can comprise a cerium-containing compound derived from cerium carbonate. In other embodiments, the rare earth-containing compound comprises cerium dioxide. The first portion of fixing agent can be substantially free of arsenic prior to contacting the arsenic-containing solution or can be partially-saturated with arsenic. When partially-saturated, the fixing agent can comprise between about 0.1 mg and about 80 mg of arsenic per gram of fixing agent.

The method includes the steps of separating the arsenic-laden fixing agent from the partially-depleted solution and contacting the partially-depleted solution with a second portion of fixing agent under conditions in which at least a portion of the arsenic is fixed by the fixing agent to yield an arsenic-depleted solution. When the step of contacting the partially-depleted solution with the second portion of fixing agent yields a partially-saturated fixing agent, the method can optionally include separating the partially-saturated fixing agent from the arsenic-depleted solution. In such an embodiment, the method optionally include the steps of contacting the partially-saturated fixing agent with a fresh portion of an arsenic-containing solution under conditions in which at least a portion of the arsenic is fixed by the partially-saturated fixing agent to give a second partially-depleted solution and an arsenic-laden fixing agent, and separating the second partially-depleted solution from the arsenic-laden fixing agent. Such a method can also optionally include the step of contacting the second partially-depleted solution with a third portion of fixing agent under conditions in which at least a portion of the arsenic is fixed by the fixing agent to give an arsenic-depleted solution.

Where the arsenic-depleted solution comprises a recoverable metal, the method can optionally include the step of separating the recoverable metal from the arsenic-depleted solution. The recoverable metal can include a metal from Group IA, Group IIA, Group VIII, and the transition metals. The recoverable metal can be separated from the arsenic-depleted solution by combining the arsenic-depleted solution with a process stream in a metal refining process, precipitating the recoverable metal from the arsenic-depleted solution and/or electrolyzing the arsenic-depleted solution. The metal refining process can include electrolyzing the arsenic-depleted solution. When the recoverable metal is in solution, the fixing agent is preferably an insoluble compound that does not react with the recoverable metal to form an insoluble product.

The pH of the arsenic-containing solution can be less than about 7 when the arsenic-containing solution is contacted with the first portion of fixing agent. More specifically, the pH of the arsenic-containing solution can be less than about 4, and still more specifically, the pH of the arsenic-containing solution can be less than about 3 when the arsenic-containing solution is contacted with the first portion of fixing agent. In other embodiments, the pH of the arsenic-containing solution can be more than about 7 when the arsenic-containing solution is contacted with the first portion of fixing agent. More specifically, the pH of the arsenic-containing solution can be more than about 9, and still more specifically, the pH of the arsenic-containing solution can be more than about 10 when the arsenic-containing solution is contacted with the first portion of fixing agent.

The method can also optionally include the step of forming the arsenic-containing solution by contacting an arsenic-bearing material with a leaching agent comprising one or more of an inorganic salt, an inorganic acid, an organic acid and an alkaline agent. When the leaching agent includes an alkaline agent, the alkaline agent can include sodium hydroxide. The arsenic-containing solution can comprise more than about 1000 ppm sulfate when the arsenic-containing solution is contacted with the first portion of fixing agent.

In another embodiment, the present invention provides an apparatus for separating arsenic from an arsenic-containing solution. The apparatus includes a first contact zone adapted to receive an arsenic-containing solution. The first contact zone has a fixing agent for contacting the arsenic-containing solution and fixing at least a portion of the arsenic to yield a partially-depleted solution. The fixing agent comprises a rare earth-containing compound. The rare-earth containing compound can include one or more of cerium, lanthanum, or praseodymium. More specifically, the rare-earth containing compound can comprise a cerium-containing compound derived from cerium carbonate. In other embodiments, the rare earth-containing compound comprises cerium dioxide.

A second contact zone is also included that is adapted to receive the partially-depleted solution, and which has a fixing agent for contacting the partially-depleted solution and fixing at least a portion of the arsenic to yield an arsenic-depleted solution. The apparatus further includes a first separator disposed intermediate the first contact zone and the second contact zone for separating fixing agent from the partially-depleted solution.

The apparatus can optionally include a second separator connected to the second contact zone for separating the arsenic-depleted solution from fixing agent. When present, the second separator can include an outlet for providing fluid communication with the first contact zone for directing a partially saturated fixing agent to the first contact zone.

The apparatus can also optionally include a filtration unit operably connected to the first separator for receiving the arsenic-laden fixing agent and producing a filtrate. When present, the filtration unit can include an outlet for providing fluid communication with the first contact zone for directing the filtrate to the first contact zone.

The apparatus can optionally include a metal recovery unit for separating a recoverable metal from the arsenic-depleted solution. The metal recovery unit can comprise one or more of a precipitation vessel and/or an electrolyzer.

### BRIEF DESCRIPTION OF THE DRAWINGS

The invention may be understood by reference to the following description taken in conjunction with the accompanying drawings.

FIG. 1 is a flow chart representation of a method of the present invention.

FIG. 2 is a schematic view of an apparatus of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

Illustrative embodiments of the invention are described below. In the interest of clarity, not all features of an actual embodiment are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover it will be appreciated that such a development effort might be complex and time-consuming, but would nevertheless be a routine undertaking for those of ordinary skill in the art having the benefit of this disclosure.

It will be understood that the method and apparatus disclosed herein can be used to treat any aqueous solution that contains undesirable amounts of arsenic. Examples of such solutions include, among others, well water, surface waters, such as water from lakes, ponds and wetlands, agricultural waters, industrial process streams, wastewater and effluents from industrial processes, solutions formed from industrial waste and byproducts and geothermal fluids. The arsenic-containing solution can also contain other inorganic contaminants, such as selenium, cadmium, lead, mercury, chromium, nickel, copper and cobalt, and certain organic contaminants. A method and apparatus of the present invention can remove arsenic from such solutions even when elevated concentrations of such inorganic contaminants are present. More specifically, arsenic is effectively removed from solutions comprising more than about 1000 ppm sulfate. Generally, a method and apparatus of the present invention can be used to treat any aqueous solution containing more than about 20 ppb arsenic and is effective for treating solutions containing more than about 1000 ppb arsenic. Moreover, the method and apparatus is effective in decreasing such arsenic levels to an amount less than about 20 ppb, in some cases less than about 10 ppb, in others less than about 5 ppb and in still others less than about 2 ppb.

It has been determined that the adsorption capacity of certain fixing agents for removing arsenic from aqueous solutions is at least in part dependent on the concentration of arsenic in those solutions. More specifically, it has been determined that for a given quantity of fixing agent that comprises a rare earth-containing compound, a greater quantity of arsenic can be removed from solution by contacting the solution with two or more portions of the fixing agent and separating the arsenic-laden fixing agent from the solution between such contacting steps than if the solution were treated with that quantity of fixing agent in a single contact stage. Moreover, the method can be used to effectively remove arsenic from such solutions over a wide range of pH levels, and at extreme pH values, eliminating the need to alter and/or maintain the pH of the solution within a narrow range.

In one aspect of the present invention, a method is provided for separating arsenic from an arsenic-containing solution. The method includes the step of contacting an arsenic-containing solution with a first portion of fixing agent comprising a rare earth-containing compound under conditions in which at least a portion of the arsenic is fixed by the fixing agent to yield a partially-depleted solution and an arsenic-laden fixing agent. The arsenic-laden fixing agent is separated from the partially-depleted solution, and the partially-depleted solution is contacted with a second portion of fixing agent under conditions in which at least a portion of the arsenic is fixed by the fixing agent to yield an arsenic-depleted solution.

The arsenic-containing solution is contacted with the first portion of fixing agent in a tank, container or other vessel suitable for holding such solutions and materials. The solution is at a temperature and pressure, usually ambient conditions, such that the solution remains in the liquid state, although elevated temperature and pressure conditions may be used. The tank may optionally include a mixer or other means for promoting agitation and contact between the arsenic-containing solution and the fixing agent. Non-limiting examples of suitable vessels are described in U.S. Pat. No. 6,383,395, which description is incorporated herein by reference. An apparatus of the present invention comprises a first contact zone and a second contact zone with a separator disposed therebetween. The first contact zone and the second contact zone can be housed within a common vessel or reactor, or may be housed separately.

The fixing agent can be any rare earth-containing compound that is effective at fixing arsenic in solution through precipitation, adsorption, ion exchange or other mechanism. The fixing agent can be soluble, slightly soluble or insoluble in the aqueous solution. In some embodiments, the fixing agent has a relatively high surface area of at least about 70 m³/g, and in some cases more than about 80 m³/g, and in still other cases more than 90 m³/g.

The fixing agent can include one or more of the rear earths including lanthanum, cerium, praseodymium, neodymium, promethium, samarium, europium, gadolinium, terbium, dysprosium, holmium erbium, thulium, ytterbium and lutetium. Specific examples of such materials that have been described as being capable of removing arsenic from aqueous solutions include trivalent lanthanum compounds (U.S. Pat. No. 4,046,687), soluble lanthanide metal salts (U.S. Pat. No. 4,566,975), lanthanum oxide (U.S. Pat. No. 5,603,838), lanthanum chloride (U.S. Pat. No. 6,197,201), mixtures of lanthanum oxide and one or more other rare earth oxides (U.S. Pat. No. 6,800,204), cerium oxides (U.S. Pat. No. 6,862,825); mesoporous molecular sieves impregnated with lanthanum (U.S. Patent Application Publication No. 20040050795), and polyacrylonitrile impregnated with lanthanide or other rare earth metals (U.S. Patent Application Publication No. 20050051492). It should be understood that such rare earth-containing fixing agents may be obtained from any source known to those skilled in the art.

In some embodiments, the rare-earth containing compound can comprise one or more of cerium, lanthanum, or praseodymium. Where the fixing agent comprises a compound containing cerium, the fixing agent can be derived from cerium carbonate. More specifically, such a fixing agent can be prepared by thermally decomposing a cerium carbonate or cerium oxalate in a furnace in the presence of air. When the fixing agent comprises cerium dioxide, it is generally preferred to use solid particles of cerium dioxide, which are insoluble in water and relatively attrition resistant. Water-soluble cerium compounds such as ceric ammonium nitrate, ceric ammonium sulfate, ceric sulfate, and ceric nitrate can also be used as the fixing agent, particularly where the concentration of arsenic in solution is high.

The fixing agent comprising the rare earth-containing compound can be present the first portion of fixing agent that is contacted with the arsenic-containing solution, the second portion of fixing agent that is contacted with a partially depleted solution or in each of the first, second and any additional portions of the fixing agent. The first portion of fixing agent can be substantially free of arsenic prior to contacting the arsenic-containing solution or the first portion can be partially-saturated with arsenic. When partially-saturated, the fixing agent can comprise between about 0.1 mg and about 80 mg of arsenic per gram of fixing agent.

Optionally, a fixing agent that does not contain a rare earth compound can also be used in the methods and apparatus of the present invention. Such optional fixing agents can include any solid, liquid or gel that is effective at fixing arsenic in solution through precipitation, adsorption, ion exchange or some other mechanism. These optional fixing agents can be soluble, slightly soluble or insoluble in the aqueous solution. Optional fixing agents can include particulate solids that contain cations in the +3 oxidation state that react with the arsenate in solution to form insoluble arsenate compounds. Examples of such solids include alumina, gamma-alumina, activated alumina, acidified alumina such as alumina treated with hydrochloric acid, metal oxides containing labile anions such as aluminum oxychloride, crystalline alumino-silicates such as zeolites, amorphous silica-alumina, ion exchange resins, clays such as montmorillonite, ferric salts, porous ceramics. Optional fixing agents can also include calcium salts such as calcium chloride, calcium hydroxide, and calcium carbonate, and iron salts such as ferric salts, ferrous salts, or a combination thereof. Examples of iron-based salts include chlorides, sulfates, nitrates, acetates, carbonates, iodides, ammonium sulfates, ammonium chlorides, hydroxides, oxides, fluorides, bromides, and perchlorates. Where the iron salt is a ferrous salt, a source of hydroxyl ions may also be required to promote the co-precipitation of the iron salt and arsenic. Such a process and materials are described in more detail in U.S. Pat. No. 6,177,015, issued Jan. 23, 2001 to Blakey et al. Other optional fixing agents are known in the art and may be used in combination with the rare earth-containing fixing agents described herein. Further, it should be understood that such optional fixing agents may be obtained from any source known to those skilled in the art.

Particulate solids such as insoluble fixing agents and insoluble arsenic-containing compounds are separated from the various solutions described herein for further processing. Any liquid-solids separation technique, such as filtration, gravity settling, centrifuging, hydrocycloning or the like can be used to remove such particulate solids. An optional flocculant, coagulant or thickener can also be added to the solution before the particulate solids are removed. Such agents are useful for achieving a desired particle size and improving the settling properties of the arsenic-laden fixing agent. Examples of inorganic coagulants include ferric sulfate, ferric chloride, ferrous sulfate, aluminum sulfate, sodium aluminate, polyaluminum chloride, aluminum trichloride among others. Organic polymeric coagulants and flocculants can also be used, such as polyacrylamides (cationic, nonionic, and anionic), EPI-DMA's (epichlorohydrin-dimethylamines), DADMAC's (polydiallydimethyl-ammonium chlorides), dicyandiamide/formaldehyde polymers, dicyandiamide/amine polymers, natural guar, etc.

In one embodiment, an arsenic-laden fixing agent is separated from a partially depleted solution in a first separator. The arsenic laden fixing agent is then directed to a filtration unit that is connected to the separator where the fixing agent is further filtered to produce a filtrate and arsenic-laden solids. The solids are directed out of the filtration unit for appropriate disposal or further handling. The filtration unit has an outlet in fluid communication with a second contract zone for recycling the filtrate to the second contract zone where it is combined with the partially-depleted solution and contacted with fresh fixing agent.

In another embodiment, a mixture of an arsenic-depleted solution and a partially saturated fixing agent are directed out of a second contact zone and into a second separator for separating the solution from the fixing agent. The arsenic-depleted solution is directed out of the separator for use, disposal or additional processing. The separator has an outlet in fluid communication with the first contact zone for directing a slurry of the partially-saturated fixing agent to the first contact zone where it contacts in-coming fresh arsenic-containing solution.

The rare earth-containing fixing agents of the present invention are particularly advantageous in their ability to remove arsenic from solution over a wide range of pH values and at extreme pH values. The pH of the arsenic-containing solution can be less than about 7 when the arsenic-containing solution is contacted with the first portion of fixing agent. More specifically, the pH of the arsenic-containing solution can be less than about 4, and still more specifically, the pH of the arsenic-containing solution can be less than about 3 when the arsenic-containing solution is contacted with the first portion of fixing agent. In other embodiments, the pH of the arsenic-containing solution can be more than about 7 when the arsenic-containing solution is contacted with the first portion of fixing agent. More specifically, the pH of the arsenic-containing solution can be more than about 9, and still more specifically, the pH of the arsenic-containing solution can be more than about 10 when the arsenic-containing solution is contacted with the first portion of fixing agent.

To the extent that it is desirable to adjust or control the pH, an optional acid and/or alkaline addition may be added to the solution as is well known in the art. Acid addition can include the addition of a mineral acid such as hydrochloric or sulfuric acid. Alkaline addition can include the addition of sodium hydroxide, sodium carbonate, calcium hydroxide, ammonium hydroxide and the like.

When the arsenic-containing solution includes a recoverable metal, the method can optionally include the step of separating the recoverable metal from the arsenic-depleted solution in a metal recovery unit connected to the second contact zone. As used herein, recoverable metal can include virtually any metal of interest, but specifically includes metals from Group IA, Group IIA, Group VIII, and the transition metals. Where the recoverable metal is in solution in the arsenic containing solution, the fixing agent is preferably an insoluble compound that selectively adsorbs arsenic from the solution and does not react or reacts only weakly with the recoverable metal to form an insoluble product. The recoverable metal can be separated from the arsenic-depleted solution by combining the arsenic-depleted solution with a process stream in a metal refining process. In some embodiments, the arsenic-depleted solution can be electrolyzed to separate the recoverable metal from solution. By way of example, the removal of contaminants to form a solution for separating various metals through electrorefining processes is described in detail in U.S. Pat. No. 6,569,224 issued May 27, 2003 to Kerfoot et al. In other embodiments, the recoverable metal can be precipitated from the arsenic-depleted solution in a precipitation vessel connected to the second contact zone.

When the step of contacting the partially-depleted solution with the second portion of fixing agent yields a partially-saturated fixing agent, the method can optionally include separating the partially-saturated fixing agent from the arsenic-depleted solution. In such an embodiment, the method can further include the steps of contacting the partially-saturated fixing agent with a fresh portion of an arsenic-containing solution under conditions in which at least a portion of the arsenic is fixed by the partially-saturated fixing agent to give a second partially-depleted solution and an arsenic-laden fixing agent. The second partially-depleted solution is separated from the arsenic-laden fixing agent. Such a method can also optionally include the step of contacting the second partially-depleted solution with a third portion of fixing agent under conditions in which at least a portion of the arsenic is fixed by the fixing agent to give an arsenic-depleted solution.

Arsenic can be extracted from solids such as contaminated soils, industrial byproducts and waste materials by leaching or extraction to release the arsenic from such solids. As a result, the method can also optionally include the step of forming the arsenic-containing solution by contacting an arsenic-bearing material with an arsenic extraction agent comprising one or more of an inorganic salt, an inorganic acid, an organic acid and an alkaline agent. Specific examples of inorganic salt arsenic extraction agents include potassium salts such as potassium phosphate, potassium chloride, potassium nitrate, potassium sulfate, sodium perchlorate and the like. Examples of inorganic acids that may be used to extract arsenic from solids include sulfuric acid, nitric acid, phosphoric acid, hydrochloric acid, perchloric acid and mixtures thereof. Organic acid extractants can include citric acid, acetic acids and the like. Alkaline agents can include sodium hydroxide among others. The arsenic-bearing material is contacted with an extraction agent in a tank, container or other vessel suitable for holding such solutions and materials. Pumps, mixers or other suitable means may be included for promoting agitation and contact between the extraction agent and the arsenic-bearing materials. A more detailed description of arsenic extraction agents and their use may be had by reference to M. Jang et al., “Remediation Of Arsenic-Contaminated Solids And Washing Effluents”, Chemosphere, 60, pp 344-354, (2005); M. G. M. Alam et al., “Chemical Extraction of Arsenic from Contaminated Soil”, J. Environ Sci Health A Tox Hazard Subst Environ Eng., 41 (4), pp 631-643 (2006); and S. R. Al-Abed et al., “Arsenic Release From Iron Rich Mineral Processing Waste; Influence of pH and Redox Potential”, Chemosphere, 66, pp 775-782 (2007).

### DETAILED DESCRIPTION OF THE FIGURES

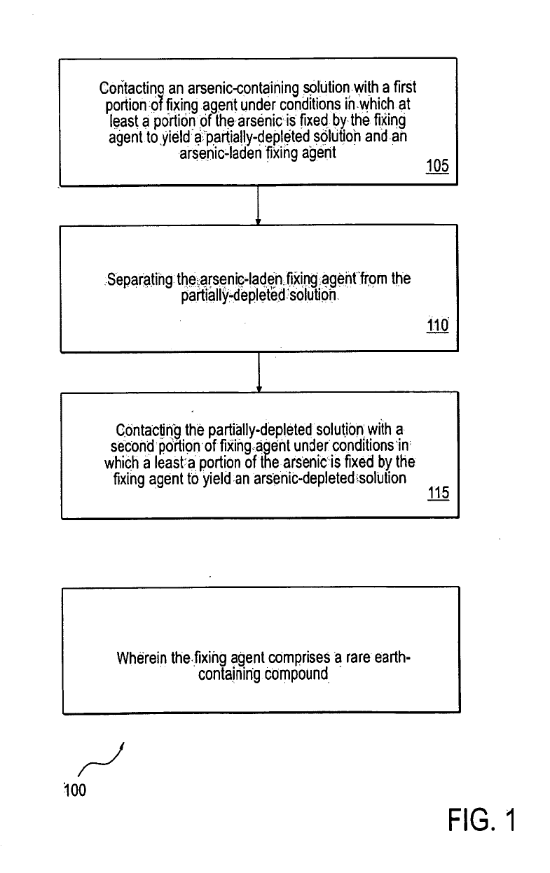

FIG. 1 is a flow chart representation of method 100. Method 100 includes step 105 of contacting an arsenic-containing solution with a first portion of fixing agent under conditions in which at least a portion of the arsenic is fixed by the fixing agent to yield a partially-depleted solution and an arsenic-laden fixing agent. In step 110, the arsenic-laden fixing agent is separated from the partially-depleted solution. In step 115, the partially-depleted solution is contacted with a second portion of fixing agent under conditions in which at least a portion of the arsenic is fixed by the fixing agent to yield an arsenic-depleted solution. The fixing agent comprises a rare earth-containing compound.

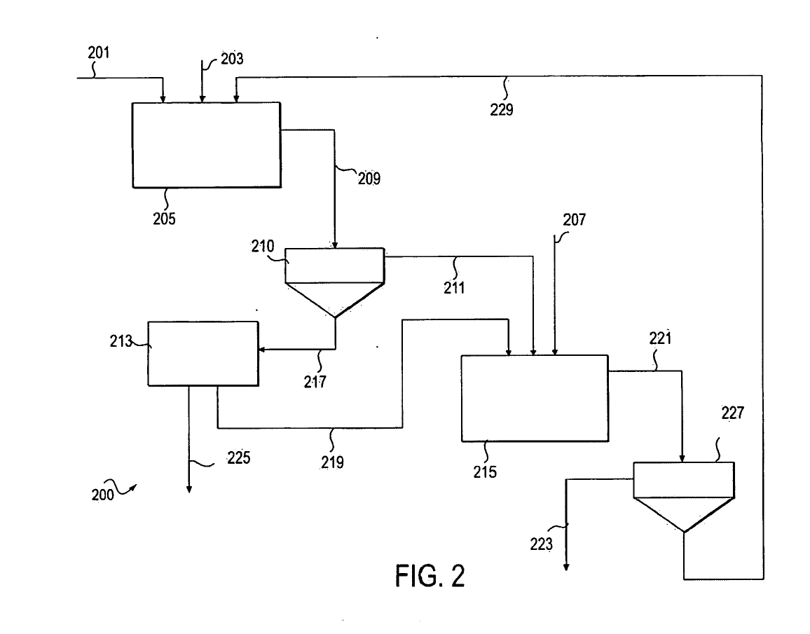

FIG. 2 is a schematic representation of apparatus 200. Apparatus 200 receives an arsenic-containing solution from a source 201 and directs it to a first contact zone within mixing tank 205. Tank 205 may optionally receive fresh fixing agent from a source 203 and a partially saturated fixing agent through line 229. The arsenic-containing solution is contacted with the fixing agent in tank 205. Tank 205 may optionally include a mixer (not shown) within the tank to promote agitation and contact between the arsenic-containing solution and the fixing agent. In this first contact zone, at least a portion of the arsenic is fixed to yield a partially-depleted solution and an arsenic-laden fixing agent.

As illustrated, both the solution and fixing agent are transferred via line 209 to separator 210 where the partially-depleted solution is separated from the arsenic-laden fixing agent. Separator 210 has an overflow outlet that directs the partially-depleted solution through line 211 to tank 215. The fixing agent is directed through an outlet to filter 213. Within filter 213, the fixing agent is filtered to yield a filtrate and arsenic-laden solids. The filtrate is routed through line 219 to tank 215 where it is recombined with the partially-depleted solution from separator 210. The arsenic-laden solids produced from the fixing agent in filter 213 are directed out through line 225.

The partially depleted solution and filtrate are combined in tank 215 and contacted with fresh fixing agent from source 207. Tank 215 may optionally include a mixer (not shown) within the tank to promote agitation and contact between the partially-depleted solution and the fixing agent. In this second contact zone, at least a portion of the arsenic is fixed to yield an arsenic-depleted solution. As illustrated, the arsenic-depleted solution and fixing agent are transferred via line 221 to separator 227 wherein the arsenic-depleted solution is separated from the fixing agent. The fixing agent in separator 227 is partially saturated with arsenic and may be recycled to first contact zone within tank 205 for contacting fresh arsenic-containing solution from source 201. The arsenic-depleted solution separated from the fixing agent in separator 227 is directed out of apparatus 200 through line 223.

### Example 1

### Single Treatment of Caustic As-Containing Mining Waste Solution

These experiments were conducted to determine the surface loading:volume ratio necessary to treat the caustic As-containing solution. The caustic As-containing solution consisted of 5-7 g/L As (III), 20 g/L Na₂CO₃, 4 g/L Sulfate, 4 mg/L Ni, and 1 mg/L Cu. The pH of the solution was approximately 10.5. The fixing agent used in these experiments was a high surface area ceria, prepared by thermally decomposing cerium carbonate to CeO₂ at 300° C. in a muffle furnace with adequate exposure to air.

Single treatment experiments were run using 200 mL of caustic As-containing solution at approximately 75° C. and adding between 3-20 g of the thermally decomposed cerium carbonate. Under test conditions, the ceria surface became saturated at a loading of 80 mg (As)/g (Ce). When more than 10 g of ceria was added, the arsenic concentration dropped below 0.2% and the surface was no longer able to be loaded to the saturation capacity.

Results are provided in Table 1. Observations collected over the course of two hours suggest that the system rapidly reaches a steady state, particularly when the surface becomes saturated with arsenic.

TABLE 1

| Mass | As(ppm) | As(ppm) | As(ppm) | Capacity |
|---|---|---|---|---|
| ceria (g) | 30 min | 1 hr | 2 hr | (mg/g) |
| 3.0 | 4600 | 4600 | 4700 | 80 |
| 5.0 | 3900 | 3500 | 3800 | 76 |
| 7.0 | 3000 | 3000 | 2900 | 80 |
| 10 | 1700 | 1700 | 1600 | 82 |
| 15 | 544 | 521 | 549 | 70 |
| 20 | 133 | 118 | 112 | 57 |

### Example 2

### Two-Stage Counter-Current Treatment of Caustic As-Containing Solution

A caustic As-containing solution was prepared by adding 10 g NaAsO₂, 20 g Na₂CO₃, 1 mL of 1000 ppm copper nitrate standard, 0.4 mL of 10,000 ppm nickel nitrate standard to 800 mL DI water. The caustic As-containing solution was then diluted to a full liter and the pH was titrated down to 10.5 using concentrated HCl. With the addition of the nickel sulfate and copper sulfate, a majority of nickel and copper precipitated out, due to the high pH of the caustic solution. The resulting caustic As-containing solution consisted of 5 g/L As (III), 20 g/L Na₂CO₃, 300 μg/L Ni, and 300 μg/L Cu. The fixing agent was again a high surface area ceria prepared by thermally decomposing cerium carbonate to CeO₂ at 300° C. in a muffle furnace with adequate exposure to air.

The two stage counter-current procedure was carried as follows:
Cycle 1/Stage 1: 12 g of 300 thermally decomposed cerium carbonate was added to 200 mL of the caustic As-containing solution maintained at a temperature of 70-80° C. The suspension was filtered on Watman paper, the arsenic-laden ceria was discarded, and the supernatant solution was moved to Cycle 1/Stage 2.
Cycle 1/Stage 2: The supernatant solution from Cycle 1/Stage 1 was re-treated with 12 g of fresh ceria. The twice-treated solution was filtered and the ceria was collected and transferred to Cycle 2/Stage 1.
Cycle 2/Stage 1: The ceria collected from Cycle 1/Stage 2 was added to 200 mL of fresh caustic As-containing solution. The suspension was filtered, the arsenic-saturated ceria was discarded, and the supernatant solution was advanced to Cycle 2/Stage 2.
Cycle 2/Stage 2: The supernatant solution from Cycle 2/Stage 1 was re-treated with 12 g of fresh ceria. The twice-treated solution was filtered and the ceria was collected and transferred to Cycle 3/Stage 1.
Cycle 3/Stage 1: The ceria collected from Cycle 2/Stage 2 was added to 200 mL of fresh caustic As-containing solution. The suspension was filtered, the arsenic-saturated ceria was discarded, and the supernatant solution was advanced to Cycle 3/Stage 2.
Cycle 3/Stage 2: The supernatant solution filtered in Cycle 3/Stage 1 was re-treated with 12 g of fresh ceria.

Results from this two-stage counter current treatment are shown in Table 2. Capacity (C) takes into account the amount of arsenic adsorbed to the surface in stage 2 of the previous cycle. In all cases, the twice treated solutions had an arsenic concentration of less than about 10 ppm. The two-stage counter current procedure effectively lowered arsenic concentrations 99.86% using 12 g of ceria at each stage. The observations collected over two hours support the conclusion that the adsorption kinetics are favorable, especially when the ceria surface becomes saturated with arsenic. The capacity of ceria observed in Cycle 2/Stage 1, taking into account the arsenic already adsorbed in Cycle 1/Stage 2, is comparable to the saturation capacity established from the single treatment experiments. However, relative to the single treatment tests as exemplified by Example 1, the final concentration of arsenic remaining in solution in the two-stage counter current experiment is roughly two orders of magnitude lower for the same mass of ceria.

TABLE 2

| | | | |
|---|---|---|---|
| As(ppm) | C (mg/g) | As(ppm) | C (mg/g) |

| | | |
|---|---|---|
| Time (hrs) | Stage 1 | Stage 2 |

| | | | | |
|---|---|---|---|---|
| Cycle 1 | | | | |
| 0.5 | 1070 | 77 | 0.11 | 18 |
| 1 | 1010 | 78 | 0.1 | 17 |
| 2 | 1040 | 78 | 0.1 | 17 |
| Cycle 2 | | | | |
| 0.5 | 2300 | 74 | 2.71 | 38 |
| 1 | 2250 | 74 | 2.07 | 37 |
| 2 | 2250 | 75 | 2 | 37 |
| Cycle 3 | | | | |
| 0.5 | 2890 | 85 | 8.5 | 48 |
| 1 | 2850 | 85 | 6.9 | 47 |
| 2 | 3000 | 82 | 6.5 | 50 |

### Example 3

### Two-Stage Counter-Current Treatment of Acidic As-Containing Solution

The two-stage counter-current treatment procedure used in Example 2 was also applied to an acidic As-containing solution containing 35 ppm As (III). The acidic solution was prepared by adding 18.72 mL of 5770 ppm As (III), 1074.3 g Nickel (II) Sulfate, 250 g NaCl, 0.63 g cobalt (II) sulfate, 6 mL of 1000 ppm lead nitrate standard, and 1.5 mL of 1000 ppm copper nitrate standard to 2 L of deionized water. The solution was then diluted to 3 L, to give a pH of approximately 2.

The acidic As-containing solution was then treated with thermally decomposed cerium carbonate using the two stage counter-current procedure. The process treated a liter of the acidic As-containing solution with 0.8 g of ceria. Some dissolution of the cerium fixing agent was observed and measured along with the arsenic concentration of the treated solutions. The results are provided in Table 3. In all cases, the twice treated solutions had an arsenic concentration of less than about 5 ppm.

TABLE 3

| | | | |
|---|---|---|---|
| As(ppm) | Ce (ppm) | As(ppm) | Ce (ppm) |

| | | |
|---|---|---|
| Time (hrs) | Stage 1 | Stage 2 |

| | | | | |
|---|---|---|---|---|
| Cycle 1 | | | | |
| 0.5 | 15.1 | 5.0 | 0.6 | 9.9 |
| 1 | 11.7 | 7.4 | 0.3 | 10.6 |
| 2 | 9.5 | 8.8 | 0.2 | 10.2 |
| Cycle 2 | | | | |
| 0.5 | 22.3 | 6.1 | 2.4 | 10.2 |
| 1 | 19.2 | 7.3 | 1.4 | 10.8 |
| 2 | 18.7 | 8.7 | 1.0 | 10.8 |
| Cycle 3 | | | | |
| 0.5 | 25.5 | 5.6 | 4.9 | 9.3 |
| 1 | 24.2 | 7.3 | 3.5 | 10.0 |
| 2 | 24.0 | 8.2 | 2.6 | 10.4 |

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for separating arsenic from an arsenic-containing solution, the method comprising the steps of:
contacting an arsenic-containing solution with a first portion of fixing agent under conditions in which at least a portion of the arsenic is fixed by the fixing agent to yield a partially-depleted solution and an arsenic-laden fixing agent, wherein the fixing agent comprises a rare earth-containing compound;
separating the arsenic-laden fixing agent from the partially-depleted solution; and
contacting the partially-depleted solution with a second portion of fixing agent under conditions in which at least a portion of the arsenic is fixed by the fixing agent to yield an arsenic-depleted solution.

2. The method of claim 1, wherein the arsenic-depleted solution comprises a recoverable metal from Group IA, Group IIA, Group VIII and the transition metals.

3. The method of claim 2, further comprising the step of combining the arsenic-depleted solution with a process stream in a metal refining process to separate the recoverable metal.

4. The method of claim 2, further comprising precipitating the recoverable metal from the arsenic-depleted solution.

5. The method of claim 2, further comprising electrolyzing the arsenic-depleted solution to separate the recoverable metal.

6. The method of claim 1, wherein the step of contacting the partially-depleted solution with the second portion of fixing agent yields a partially-saturated fixing agent, the method further comprising the step of:
separating the partially-saturated fixing agent from the arsenic-depleted solution.

7. The method of claim 6, further comprising:
contacting the partially-saturated fixing agent with a fresh portion of an arsenic-containing solution under conditions in which at least a portion of the arsenic is fixed by the partially-saturated fixing agent to give a second partially-depleted solution and an arsenic-laden fixing agent; and
separating the second partially-depleted solution from the arsenic-laden fixing agent.

8. The method of claim 7, further comprising contacting the second partially-depleted solution with a third portion of fixing agent under conditions in which at least a portion of the arsenic is fixed by the fixing agent to give an arsenic-depleted solution.

9. The method of claim 2, wherein the recoverable metal is in solution and the fixing agent comprises an insoluble compound that does not react with the recoverable metal to form an insoluble product.

10. The method of claim 1, wherein the rare earth-containing compound comprises one or more of cerium, lanthanum, or praseodymium.

11. The method of claim 10, wherein the rare earth-containing compound comprises a cerium-containing compound derived from cerium carbonate.

12. The method of claim 10, wherein the rare earth-containing compound comprises cerium dioxide.

13. The method of claim 1, wherein the arsenic-containing solution has a pH of less than about 7 when the arsenic-containing solution is contacted with the first portion of fixing agent.

14. The method of claim 13, wherein the arsenic-containing solution has a pH of less than about 4 when the arsenic-containing solution is contacted with the first portion of fixing agent.

15. The method of claim 14, wherein the arsenic-containing solution has a pH of less than about 3 when the arsenic-containing solution is contacted with the first portion of fixing agent.

16. The method of claim 1, wherein the arsenic-containing solution has a pH of more than about 7 when the arsenic-containing solution is contacted with the first portion of fixing agent.

17. The method of claim 16, wherein the arsenic-containing solution has a pH of more than about 9 when the arsenic-containing solution is contacted with the first portion of fixing agent.

18. The method of claim 17, wherein the arsenic-containing solution has a pH of more than about 10 when the arsenic-containing solution is contacted with the first portion of fixing agent.

19. The method of claim 1, wherein the arsenic-containing solution comprises more than about 1000 ppm sulfate when the arsenic-containing solution is contacted with the first portion of fixing agent.

20. The method of claim 1, further comprising the step of forming the arsenic-containing solution by contacting an arsenic-bearing material with a leaching agent comprising one or more of an inorganic salt, an inorganic acid, an organic acid and an alkaline agent.

21. The method of claim 20, wherein the alkaline agent comprises sodium hydroxide.

22. The method of claim 1, wherein the arsenic-depleted solution comprises arsenic in an amount of less than about 20 ppm.

23. The method of claim 1, wherein the first portion of fixing agent is substantially free of arsenic prior to contacting the arsenic-containing solution.

24. The method of claim 1, wherein the first portion of fixing agent is at least partially-saturated with arsenic.

25. The method of claim 24, wherein the fixing agent partially-saturated with arsenic comprises between about 0.1 mg and about 80 mg of arsenic per gram of fixing agent.

26. An apparatus for separating arsenic from an arsenic-containing solution, the apparatus comprising:
a first contact zone adapted to receive an arsenic-containing solution, the first contact zone having fixing agent for contacting the arsenic-containing solution and fixing at least a portion of the arsenic to yield a partially-depleted solution, wherein the fixing agent comprises a rare earth-containing compound;
a second contact zone adapted to receive the partially-depleted solution, the second contact zone having fixing agent for contacting the partially-depleted solution and fixing at least a portion of the arsenic to yield an arsenic-depleted solution; and
a first separator disposed intermediate the first contact zone and the second contact zone for separating fixing agent from the partially-depleted solution.

27. The apparatus of claim 26, wherein the rare earth-containing compound comprises one or more of cerium, lanthanum, or praseodymium.

28. The apparatus of claim 27, wherein the rare earth-containing compound comprises a cerium-containing compound derived from cerium carbonate.

29. The apparatus of claim 27, wherein the rare earth-containing compound comprises cerium dioxide.

30. The apparatus of claim 26 further comprising a second separator connected to the second contact zone for separating the arsenic-depleted solution from fixing agent.

31. The apparatus of claim 30, wherein the second separator comprises an outlet for providing fluid communication with the first contact zone for directing a partially saturated fixing agent to the first contact zone.

32. The apparatus of claim 26, further comprising a filtration unit operable connected to the first separator for receiving the arsenic-laden fixing agent and producing a filtrate.

33. The apparatus of claim 32, wherein the filtration unit comprises an outlet for providing fluid communication with the first contact zone for directing the filtrate to the first contact zone.

34. The apparatus of claim 26, further comprising a metal recovery unit connected to the second contact zone for separating a recoverable metal from the arsenic-depleted solution.

35. The apparatus of claim 34, wherein the metal recovery unit comprises one or more of a precipitation vessel and an electrolyzer.
